(19) United States
(12) Patent Application Publication
(10) Pub. No.: US 2004/0009700 A1
(43) Pub. Date: Jan. 15, 2004

(54) Motion activated plug-in outlet

(76) Inventor: Jitendra Ambalal Patel, Wappingers Falls, NY (US)

Correspondence Address: JITENDRA AMBALAL PATEL, 8 SHERRYWOOD ROAD, WAPPINGERS FALLS, NY, 12590, US

(21) Appl. No.: 10/192,096

(22) Filed: Jul. 11, 2002

(51) Int. Cl. H01R 3/00

(52) U.S. Cl. 439/488

(57) ABSTRACT

A motion activated plug-in type electrical outlet which conveniently plugs into a standard power outlet is disclosed. The device allows non-motion sensor equipped ordinary household electrical devices to function as if they are equipped with a motion sensor. The device does not contain any switch making it easy to use by everyone, particularly, those who may be suffering from mental or physical disability. The device can be used with any wall or ceiling mounted electrical outlet to automatically turn ON and OFF ordinary household plug-in type electrical devices such as night lights, table/floor lamps, table top water fountains, Christmas and other decorative lights, radios, heaters, and thereof, when presence of one or more person is detected. This device conveniently plugs into any wall power outlet by means of two or three prongs without requiring new wiring or re-wiring of the existing electric circuit.

### BACKGROUND OF THE INVENTION

Basic motion sensor operated lighting systems are well known in prior art. Generally, these devices automatically turn on a light source when presence of one or more person is detected within its range. The light source continues to illuminate for a preset time after the detection ceases. A light sensitive component is usually incorporated to inhibit the activation of the light source when the ambient light level is high. However, devices equipped with both motion detection and a light sensitive component such as a photocell have limitations as it can not be used for controlling devices other than household light fixtures during the day time when ambient light level is high. There are two general categories, namely indoor and outdoor automatic motion activated lights. Both of these categories require installation and wiring or rewiring, usually by trained professionals. Indoor automatic and security lights such as disclosed in U.S. Pat. No. 5,015,994 by Kenneth Hoberman and Kim Kirwan solve the installation problem as they can be plugged into a standard wall power outlet by a prolonged plug built into the self-contained lighting devices. However, their application is limited because existing wall outlets may not be situated in a favorable location for detection, illumination and/or ambient light sensing. This constraint may render it impossible to use such devices under certain circumstances. In addition, the self-contained construction of such indoor devices limit the type, size and wattage of the bulbs used. A motion and/or light activated outlet disclosed in U.S. Pat. No. 5,673,022 by Jitendra A. Patel solves the installation problem as this invention is plugged into a standard wall power outlet but one has to set motion and photocell switch to the desired position. While this feature gives someone a flexibility, it is inconvenient for those who may be suffering from disability.

While all preceding systems of the prior art have brought about a certain degree of convenience and protection providing automatic lighting and security, there remains a need for a device that is activated by motion without having to set switches, easily installed, user friendly and can be used to provide illumination, or to turn on devices such as radios, night lights, tabletop water fountains, Christmas lights, table and floor fan, plug-in air fresheners etc. in places such as bathrooms, living rooms, family rooms and hallways regardless of the ambient light conditions.

There remains the need for a small electronic/electrical device which is capable of allowing consumers to operate many non-motion sensor equipped household electrical products to operate as if they are equipped with a motional sensor in response to the presence of one or more persons in the area that are often dark (e.g. bathrooms and hallways), which is small, lightweight, requires no tools to install, no re-wiring, easily portable, and which can be installed and de-installed at will by consumers.

### BRIEF SUMMARY OF THE INVENTION

In accordance with the teachings of this invention, a novel device is provided which is small, inexpensive, and conveniently plugs into a standard power outlet, thereby allowing easy installation and de-installation by consumers, and thereby allowing many non-motion sensor activated electrical devices to operate as if these devices are motion sensor equipped. This device includes only a motion detector so that the operation of non-motion detector equipped devices occur in the presence of one or more persons regardless of the ambient light level. Means is provided for causing device to operate for a desired amount of time after the cessation of movement. A photoelectric device is not provided so that the devices plugged into this present invention will operate in response to motion whether the ambient light level is high or low. The device of present invention can be designed so that the activation time (duration) can either be at a fixed predetermined level, say 30 minutes, or variable, say 5 to 30 minutes.

Accordingly, this invention comprises a control for electrically energizing a device means, said control having: metal prongs for connection to a source of electrical energy, output means (female receptacles) for connection of electrical energy from the control to said device means, to detect the presence of moving infrared radiation sources; said control having modes of operation which comprises a operation mode wherein said output means is energized upon the detection of a moving infrared radiation source and remains energized for a predetermined period of time after cessation of said detection, regardless of the ambient light level allowing the said device to work 24-hours a day.

In another form the invention comprises;

(a)means for connecting non-motion sensor equipped household electrical devices by way of plugging in;

(b)means for receiving automatic inputs by detecting the presence of moving infrared radiation sources;

(c)output means which can provide illumination or other functions when supplied with a source of alternating current electrical power;

(d) means to provide an electrical connection to a source of alternating current electrical power.

Preferably the mode of operation can be obtained by devices such as passive infrared motion detector. These sensors are well known in the prior art.

Preferably the control means includes means to interrupt the passage of electrical power to the illumination means for a predetermined interval, and means to maintain the passage of electrical power for a predetermined duration.

Preferably the control means includes devices covered in prior art such as a passive infrared (PIR) motion detector, proximity sensors, status indicators, and associated electronic circuits all of which are housed within a container which has electrical and mechanical connecting means.

Preferably the control means includes an alarm mode which will sound an alarm or send a signal to a local or remote alarm sounder upon detection of the presence of an intruder.

### BRIEF DESCRIPTION OF THE SEVERAL VIEWS OF THE DRAWINGS

FIG. 1 is a front view of the present invention.

FIG. 2 is a left-side view of the present invention.

FIG. 3 is a right-side view of the present invention.

FIG. 4 is a rear view of the present invention.

FIG. 5 is a top view of the present invention.

FIG. 6 shows the present invention plugged into a wall outlet.

### DETAILED DESCRIPTION OF THE INVENTION

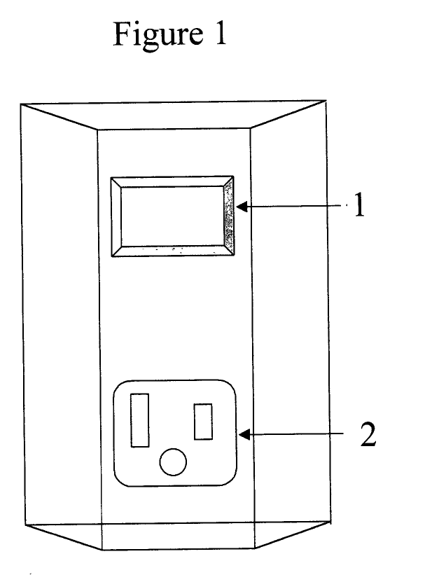

FIG. 1 is a front view of the present invention. The motion detector (1), preferably the passive infrared type is positioned on top to avoid obstruction of the motion sensor by wires and/or plugs that are intended for use in combination with the present invention. A motion sensor activated outlet (2) is also shown and is used for plugging in (or removal) of electrically operated household devices such as table and floor lamps, table and floor fans, radiant heaters, radios, night lights, tabletop water fountains, plug-in air fresheners etc. Only one motion activated outlet is shown but the device can be manufactured with two or more outlets and can be placed on front or on sides.

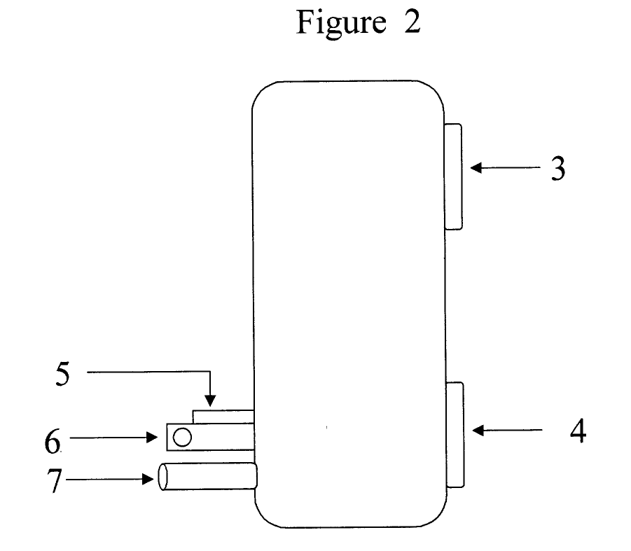

FIG. 2 is a left-side view of the present invention. Motion sensor (3) is placed at top as shown. Also shown, a motion activated outlet (4), a hot pin (5), a neutral pin (6), and a ground pin (7) which are integral part of the present invention and are provided for plugging the said device into the wall or ceiling mounted conventional receptacles. Although the device is shown with a ground pin at the bottom position, the device of this invention can also be manufactured with a ground pin at the top position or without a ground pin to allow use of the present device with older type receptacles. The device can be manufactured with a removable and/or movable ground plug (e.g. screw-in type). By virtue of the design of the said invention, the lower female receptacle on the wall or ceiling mounted outlet remains assessable for use, if needed.

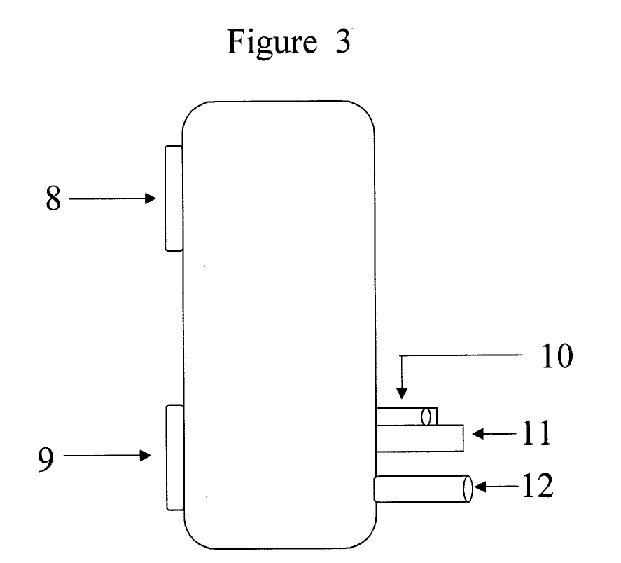

FIG. 3 is a right-side view of the present invention. In addition to the motion sensor (8), motion activated outlet (9), neutral pin (10), hot pin (11) and ground pin (12), are shown.

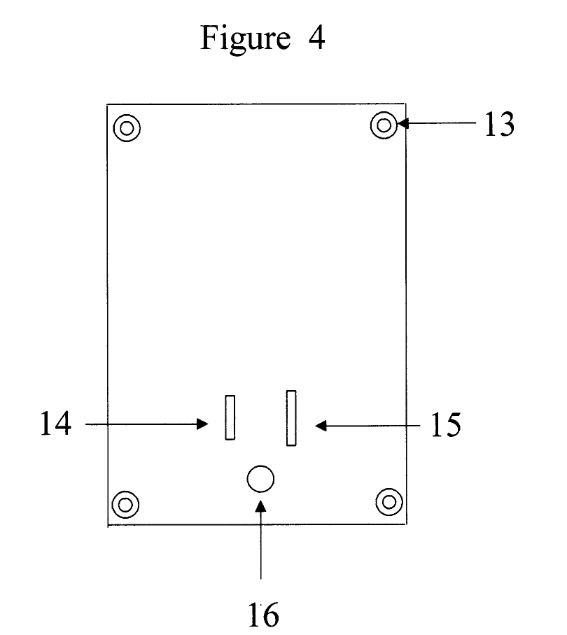

FIG. 4 is a rear view of the present invention. Hot pin (14), neutral pin (15), a ground pin (16) are shown. These pins supply power to the present invention.

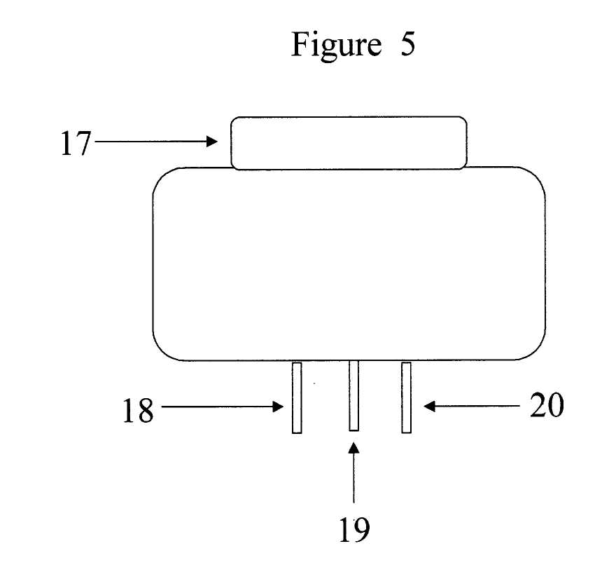

FIG. 5 is a top view of the present invention. Motion detector (17), hot pin ((18), ground pin (19), and neutral pin (20) are shown. These pins supply power to the present invention.

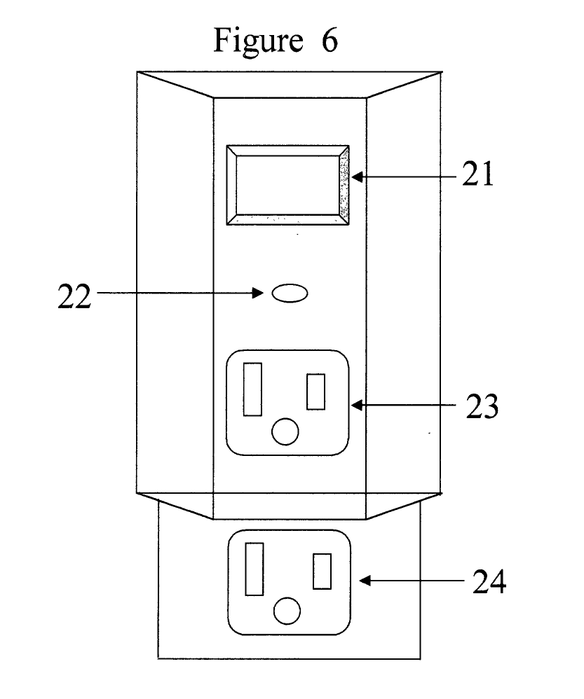

FIG. 6 shows the device of the present invention plugged into a standard wall outlet. A motion detector (21), power OF/OFF indicator (22), motion activated outlet (23), and a standard wall outlet (24) are shown. This figure shows that the design of the present invention keeps the lower non-controlled wall outlet (24) accessible for other use.

### OBJECTS OF THE INVENTION

It is therefore an object of the present invention is to provide a motion sensor equipped device for operating all non-motion sensor equipped household electrical products to turn ON and OFF without requiring re-wiring or installation regardless of the ambient light level.

A further object of the present invention is to provide an intelligent control for illumination or other purposes such as converting non-motion sensor controlled devices to behave as if they are motion sensor equipped devices. Some of the examples for such devices are: table and floor lamps, night lights, radios, plug-in air fresheners, Christmas lights, tabletop water fountains, TVs etc.

The present invention overcomes the shortcomings of the prior art by providing a control means for providing electrical power to illuminate or operate other electrical devices whenever motion is detected 24-hours a day.

The present invention will electrically connect all non-motion sensor equipped electrically operated devices such as a lamp to a source of electrical power whenever motion is detected regardless of the ambient light level. The lamp may be a fluorescent, incandescent or halogen bulb.

What is claimed is:

1. A motion sensor equipped device for electrically energizing ordinary household electrical devices, said device having input means for connection to a source of electrical energy, output means for providing electrical energy from source to electrical devices upon detection of motion.

2. The device of claim 1, further comprising means for adjusting the duration for which said output means remains energized after cessation of detection of a moving infrared radiation source.

3. The device of claim 1, further comprising means to automatically reset after a total loss of electrical energy.

4. The device of claim 1, does not affect normal functions of ordinary household electrical devices.

5. The device of claim 1, wherein the components of the control are housed in a sealed unit.

6. The device of claim 1 wherein the motion detector is a passive infrared motion detector.

7. The device of claim 1 which further comprises means for selecting a desired amount of time during which power is applied to said devices, after motion is no longer detected.

8. The device of claim 1, the motion sensing unit is mounted on the bottom of the device, or on the top of the device to avoid obstruction by wires and/or plugs of ordinary household electrical devices.

9. The device of claim 1, the motion activated outlet can be positioned on the front, or on the left side, or on the right side, of the main body of the present invention.

10. The device of claim 1, provides access to one of the two wall or ceiling mounted conventional receptacles.

11. The device of claim 1, when used in conjunction with appropriate adopters, works with various voltage powered electrical appliances and devices marketed around the globe.

12. The device of claim 1, when designed for use with power other than 120V commonly used in the USA, works with various voltage powered electrical appliances and devices marketed around the globe.

13. The device of claim 1, further including means to activate other devices for a predetermined fixed time period or for a range of time periods.
